(19) United States
(12) Patent Application Publication
(10) Pub. No.: US 2010/0091103 A1
(43) Pub. Date: Apr. 15, 2010

(54) USER INTERFACE OF MINERAL MATERIAL PROCESSING EQUIPMENT

(75) Inventors: Mika Peltonen, Tampere (FI); Hannu Heman, Kangasala (FI); Ari Posti, Rauma (FI); Jarmo Eloranta, Kangasala (FI); Jouni Mahonen, Tampere (FI)

Correspondence Address: OLIFF & BERRIDGE, PLC, P.O. BOX 320850, ALEXANDRIA, VA, 22320-4850, US

(73) Assignee: Metso Minerals Inc., Helsinki (FI)

(21) Appl. No.: 12/450,897

(22) PCT Filed: May 16, 2007
(86) PCT No.: PCT/FI2007/050283

§ 371 Date: Nov. 13, 2009

(30) Foreign Application Priority Data
Apr. 18, 2007 (FI) PCT/FI2007/050203

(51) Int. Cl. H04N 7/18; G06F 3/048; H04N 5/232

(52) U.S. Cl. 348/82; 715/771; 348/E05.042; 348/211.99; 348/E07.085

(57) ABSTRACT

User interface of a mineral processing equipment governs a mineral processing line having several units (crushers, screens) connected in series. The user interface comprises a display screen (14) and control buttons or keys and is connected through a data transmission link to sensors and actuators of the mineral processing equipment for receiving measurement data and sending control commands. The user interface is arranged to show within the display screen (14), by choice of the user
status of the mineral processing equipment in diagrammatic representation, or
a live camera view (21) of at least one point of the equipment.

The diagrammatic representations can be in form of a traffic lights (20) indicating the feeding speeds of the units.

### FIELD OF THE INVENTION

The present invention relates to a user interface of a mineral material processing equipment. Such an equipment comprises a mineral material processing line to which raw mineral material is fed and in which it is transported through subsequent processing steps such as crushing and screening. The mineral processing equipment in which the present invention can be used comprises as a rule feeding, crushing, and screening machines, and conveyors transporting the material to be processed between various processing steps and conveyors discharging processed material from the process.

Mineral material means in this context any material of rock origin which need not necessary be valuable materials because of their mineral composition but could be rock of low value which need to be comminuted to a smaller size for use as construction purposes or for other purposes. It can also be waste material containing mineral material at least partly, such as deconstruction waste (e.g. bricks, concrete, asphalt and the like).

The invention also relates to a user interface of a waste material processing equipment. Waste material can be every material that is discharged after its use and that is comminuted and/or compressed to reduce its size. Waste processing equipment contains similarities to mineral processing equipment in that it contains a processing step and transporting material to be processed to the processing step and transporting processed material away from the processing step, possibly towards another processing step. The product of the waste processing can be disposed as waste (final disposal) or used for recycling. The waste material can be metal, rubber, plastic, glass, or any mixture of these, or any other material. Car bodies are one example of waste material that is commonly processed.

### BACKGROUND OF THE INVENTION

The control of mineral material processing aims at remote control of several machines connected in series. It is the purpose that the user does not need to go to the machine in order to follow its operation or to give commands to the machine, which would require extra labour and could be even dangerous in some instances. For example if a disturbance or malfunction occurs in the process, it is better to see the cause in advance at a remote control point such as in a driver's cabin or a control room so that appropriate measures can be taken, and the problem may be even resolved without going to the site of disturbance or malfunction. The direct visual observation of the equipment may also become difficult, if the equipment is placed under a cover to shield the environment from airborne material (dust) caused by the processing. The purposes of the control of waste material processing equipment are largely the same, except that the equipment may consist of one single machine.

The control of a crushing machine from a remote control point is known from the Japanese publication JP-8-155326. In this document, the cabin of an excavator which supplies a crushing machine is equipped with a control panel 56 connected to the actuators of the crushing machine, i.e. solenoid valves 37, 38. The cabin also comprises a video survey monitor 49 connected to a video camera 32 that monitors the crusher. The video camera is controlled through another control panel 50 in the cabin. In this arrangement, the driver of an excavator can control the process by the remote control device. A similar idea is presented by the Japanese publication JP-1-168363, where the operator in a cabin of a loading machine can see the condition of the crusher on a monitor screen and control the speed of the feeding conveyor through remote control.

Finnish utility model no. 5905 shows a display device, which is located for example at the driver's cabin of an excavator and can be used to see various alarms, pressures, speeds, the status of the engine, feeding rates, etc. of a machine in a mineral material processing plant. The user of the display device can also set various values by entering corresponding data in the display device, e.g. change the pressure limits or change the operating values, for example when the material to be fed is changed. The display device is coupled in a wireless manner to a field bus connecting the sensors and actuators of the machine, and it comprises keys and/or buttons for influencing the actuators of the machine. The display device can be connected to several machines of the mineral material processing plant.

Japanese publication 8-299821 shows a control method for supplying raw ore to a jaw crusher, where a CCD camera is used for observing the grain size of the ore entering the crusher. The camera takes continuously pictures of the raw ore for an automatic control system, which by image processing decides if the grain size is so large that the grain size must be given priority over the ore level in the crusher detected by the level sensor in adjusting the feeding rate. The apparatus comprises a TV monitor for inspection of the pictures taken and it is not necessary for the automatic operation of the control system.

US Patent Application Publication 2004/0200914 shows an operating panel in a cab of a loader which loads objects to be crushed to a crusher. The operating panel comprises buttons for operating the crusher and a monitor 30 for graphically displaying the load condition of the crusher. The upper half of the monitor is made up by a screen 31 which can display the load condition graphically to the operator. The lower half of the monitor is made up by a touch type display operation switch panel 32 for selecting the working modes and settings of the crusher.

In solutions of prior art, for overall control of a mineral material processing line from a remote point, attention must be paid separately to the remote control device, load condition display, various alarms based on light or sound, and the video survey monitor. This requires extra attention for the human operator especially in a driver's cabin of mobile loading machine which supplies the mineral raw material to the processing line. Further, a driver's cabin is a place where space is limited for installing various devices.

### SUMMARY OF THE INVENTION

It is an object of the invention to provide a sophisticated solution which simplifies the work of an operator which controls and monitors the mineral or waste material processing equipment and which especially needs to get knowledge of the status of various parts of the equipment and also visual on-line information. It is also the object of the invention to provide a system through which the operator can learn to better manage the process. To solve the problems of prior art and to attain the aforementioned purpose, the present invention is mainly characterized in that the user interface is arranged to show within the display screen, by choice of the user
status of the mineral or waste processing equipment in diagrammatic representation, or
a live camera view of at least one point of the equipment.

The operator in the control point, such as in the driver's cabin, can concentrate his attention on one single screen when keeping watch over and controlling the process. It is thus possible to see the real situation on some selected spots as well as the status of the process in diagrammatic representation without a need to change the monitoring device. The live camera view can be shown whenever desired by the operator on the screen that is normally displaying an on-line page. In addition to the manual selection of the camera view, the camera view can appear automatically, for example as a “pop-up” window, when some predetermined limit in a condition of the process is attained, this limit defining a critical state, “attention state” where attention should be paid to the spot concerned.

The operator can use the same user interface for controlling the process by giving various commands. The user interface according to the invention is a compact device which fits well in a control point where available space is limited, especially in a driver's cabin.

The status of the mineral or waste processing equipment is usually the loading status or the condition of the equipment. Thus, the user interface can be used for on-line surveillance of the load of various parts caused by the process, or for on-line surveillance of the general condition of various parts to evaluate if need exists for maintenance and repair.

According to a preferred embodiment of the invention, in the process there are several distinct spots that can be visually inspected through the camera allocated for the spot. Thus, the operator can choose among several camera views which show a live situation on different spots along the mineral material or waste material processing line, or any of these views can activate automatically when a predetermined limit in the process conditions related to the spot in question is reached. The cameras are placed so that they cover the points of the equipment that are the most critical, for example where problems or disturbances in the flow or processing of the material are most likely to occur (feeding, transporting, screening, crushing). An individual camera view is arranged to appear within a window that constitutes a partial view on the screen so that it does not cover the whole screen area. It is possible for the operator to select the suitable camera settings (size and place of the window on the page) in advance on a so-called camera settings page. The showing of two or more camera views, which represent different spots, simultaneously on the screen is also possible.

The user interface also includes several possibilities to arrange a view of the screen so that the status of several sections or units of the mineral processing line, such as different machines of the equipment, can be monitored simultaneously in the same view on the screen as a diagrammatic representation. For example, if the sections or units of the equipment are two or more machines in series (with regard to the material flow through the processing line), the view can show the data of two or three machines in discrete screen areas, for example arranged in fields, “boxes” next to each other. The operator can configure these pages by choosing the most important parameters related to the status of the equipment that are to be shown simultaneously in a particular view. These parameters are chosen from an online page configuration page, which contains a list of several parameters.

The interface also contains control buttons and keys for controlling the functions of the user interface itself, for example selecting the views, but it can also contain control buttons and keys for giving commands to the process. These can be separate from the screen but integrated in the display device incorporating the screen. According to a preferred embodiment, the control buttons and keys can be made part of the screen, that is, the screen is a touch screen. In this case the control buttons and keys can be icons or symbols of some kind that can be activated by touching them. Alternatively or in addition to this arrangement, the control buttons and keys can also be activatable, “clickable”, by an external control tool such as a mouse or joystick.

Still one useful function of the user interface is messages during the use in form of text fields. These messages can inform the operator about the status of various points and they can contain suggestions or instructions for measures that should be taken. These can be arranged as “alarm pop-up frames” that will appear in similar cases as the camera views (some point of the processing line has attained an “attention state”), but they may represent different spots than covered by the cameras, for example spots that are inaccessible to cameras.

According to one advantageous embodiment of the user interface, the operator can see the speed of the mineral material processing in easily perceivable diagrammatic symbols, such as “traffic lights”. Such symbols can be allocated for each unit (machine) connected in series with respect to the material flow. The operator can learn and gain experience of the behaviour of the process through these symbols and other diagrammatic representations of various parameters.

### BRIEF DESCRIPTION OF THE DRAWINGS

The invention will be described in more detail with reference to the accompanying drawings, where

FIG. 1 shows a typical mineral material processing equipment,

FIG. 2 shows schematically the connection of the user interface to the equipment,

FIG. 3 is one example of a view (a page) of the user interface,

FIG. 4 shows a navigation module for the views (the pages),

FIG. 5 shows a view mode selection page,

FIG. 6 shows a page configuration view (page),

FIG. 7 is an example of a live camera view,

FIG. 8 shows the camera settings page,

FIG. 9 shows the page where internal delay times of the equipment can be chosen,

FIG. 10 is the example of an alarm function activated on one page, and

FIG. 11 is an example of a page according to FIG. 3 but with all fields showing a special diagrammatic representation related to the material transport and processing speed.

### DETAILED DESCRIPTION OF THE PREFERRED EMBODIMENTS

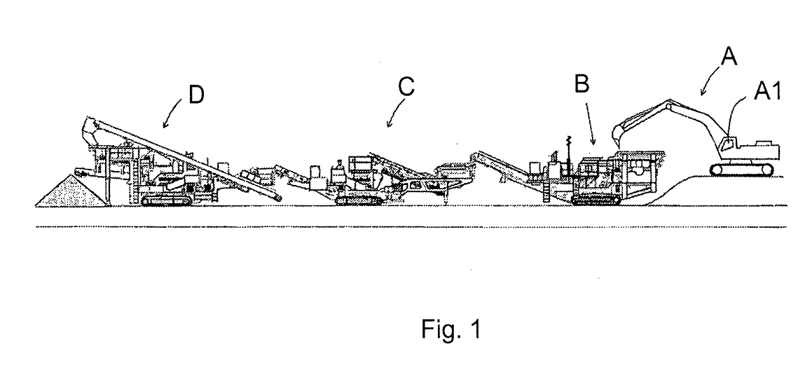

FIG. 1 shows a mineral material processing equipment at a worksite in the open where the invention can be used. In the figure, there is a feeding or loading machine A for mineral materials which is movable by means of its own driving force and whose cabin A1 constitutes a remote control point for the equipment. In the case shown in the figure, the feeding or loading machine A is an excavator. The invention is not, however, restricted to any specific feeding machine A. The feeding machine may be a wheel-mounted loader, a bulldozer, or a dumper as well.

Furthermore, the plant comprises three units for the processing of mineral materials, which are separate processing machines coupled together so that the feeding or loading machine A feeds the first machine (primary unit), i.e. a crushing machine B, and the material processed by the crushing machine B is conveyed to the next machine (secondary unit), another crushing machine C, and from there to a third machine (tertiary unit), a combined crushing and screening machine D. Both the feeding or loading machine A and the processing machines B, C, D are self-propelled, track-mounted machines. The primary unit may contain jaw crusher as the preliminary crusher and the secondary unit may contain a cone crusher as the intermediate crusher. The material is conveyed between the feeding point, crushers, screens and discharge points by conveyors. The loading machine A can be a mobile loading machine of any kind that can supply material to the feeding point (feed hopper) of the primary unit B.

FIG. 1 shows a typical arrangement, a so-called “LT train”, where LT stands for “Lokotrack” which is a trade name of Metso Minerals for the mineral processing machines. The function of the crushing machines B, C is to reduce the grain size of the material fed in them. The function of the screening machine D is to separate the produced grains into distinct grain size fractions.

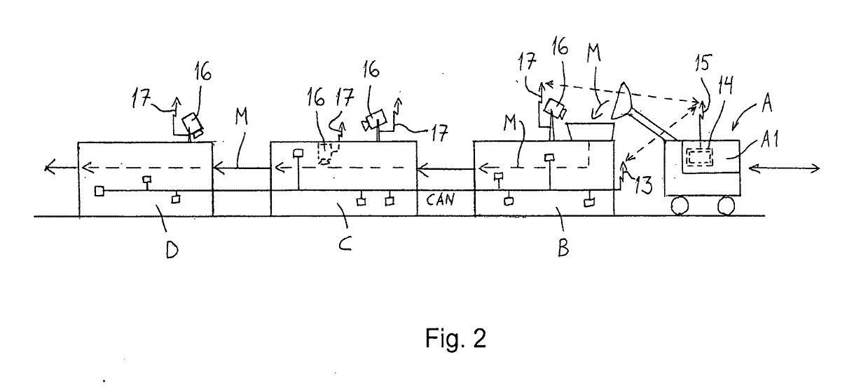

FIG. 2 shows the architecture of the control system and the connection of the user interface to the mineral material processing equipment. The figure is schematic and is intended to illustrate the flow of data and the flow of mineral material (M) in the equipment, between various units B, C, D and the feeding machine A. The machines typically comprise a field bus, in the case shown in the figure a CAN bus. The CAN bus (CAN=Controller Area Network) was originally intended for the real-time data transmission of distributed control systems for vehicles. The CAN bus connects different actuators and sensors of the machine, and it is intended for the data transmission between them. Consequently, this bus common to the different sensors and actuators is used for the transmission in digital form of data corresponding to measurement data from the sensors, as well as measurement and control messages for the actuators, as well as other messages, such as, for example, alarm messages and calculatory messages. The field bus can also be called the control bus.

The field bus 6 is connected to control modules which are connected to sensors, limit switches, safety switches, control buttons, etc. The modules are provided with a data processing capacity of their own; that is, they are “intelligent” to some extent. The equipment may have a control module of the hydraulic system (hydraulic control module, HCM), an engine control module (ECM), and a control module for the actuators, such as the feeder, the crusher, the screen, the conveyor, the magnetic separator, and the driving tracks (device control modules, DCM). A separate engine bus connects the engine control module with the engine.

The control module collects and processes information and delivers it to the field bus, wherein the other control modules can read the information, if they need it. The field bus is connected to a transmitter/receiver (transceiver) unit 13 which is arranged to transmit information transferred via the bus in a wireless manner to a user interface in the remote control point A1, i.e. a display having a display screen 14, whose function is to be described later in detail. According to a preferred embodiment, the user interface also has control buttons or keys for entering control information. The user interface is connected via an antenna 15 to the transceiver unit 13 in the machine. The data traffic of the bus between the transceiver unit 13 of the machine and the user interface takes place in a wireless manner; in other words, the wireless connection is, in a way, one extended part of the bus. Thus, the user interface at the remote control point can receive information about the status of the machine transmitted in the bus, which may be various measurement data given by different sensors, and by using the control buttons or keys of the user interface, the bus can be given control commands to control the actuators of the machine via the bus. All units B, C and D are connected through the common field bus and the transceiver unit 13 to the remote control point. The units B, C and D are interconnected through wireless links or through cables that make up the sections of the field bus between the units.

A video camera 16 is placed a the feeding point of the crushing machine and it is arranged to take live video image that is transmitted to the user interface along a radio link (wireless connection between the transmitter 17 of the video image and the antenna 15 of the user interface). As shown by the figure, the mineral processing line can contain two or more video cameras 16 which monitor different spots along the route of mineral material M, and one single unit can contain two or more cameras 16.

The data transmission between the video camera 16 and the user interface is bidirectional. Besides activating the camera image on the display screen, the user interface can be used to switch off and on the camera and, if the movements of the video camera 16 are remotely controllable, it can also be used to control its movements around one or several rotation axes or to zoom the camera, if the view given by the camera must be shifted or enlarged.

All data transmission, including video image, can be arranged through a common link between the remote control point A1 and the units B, C and D. This can be accomplished in practice by applying advanced networks, for example WLAN. This will make also the multi-point transmission (simultaneous transmission of all data to more than one remote control point) possible. One of these control points may be in the mobile loading machine and the other in a stationary control room. All known solutions of image data transmission may also be used, such as GPRS, 3G-technology, or web camera based technology.

The display screen 14 is the essential component of the user interface which is located in the remote control point A1 in relation to the processing units B, C, D of the equipment, such as in a driver's cabin of a mobile feeding or loading machine. The user interface is arranged to show various views or “pages” on the screen which can be accessed by the operator by selecting appropriate buttons or keys of the user interface. The term “view” may differ to a view on the whole area of the display screen or a view that covers only part of the screen, depending on the context. The whole screen view is synonymous with the concept “page”.

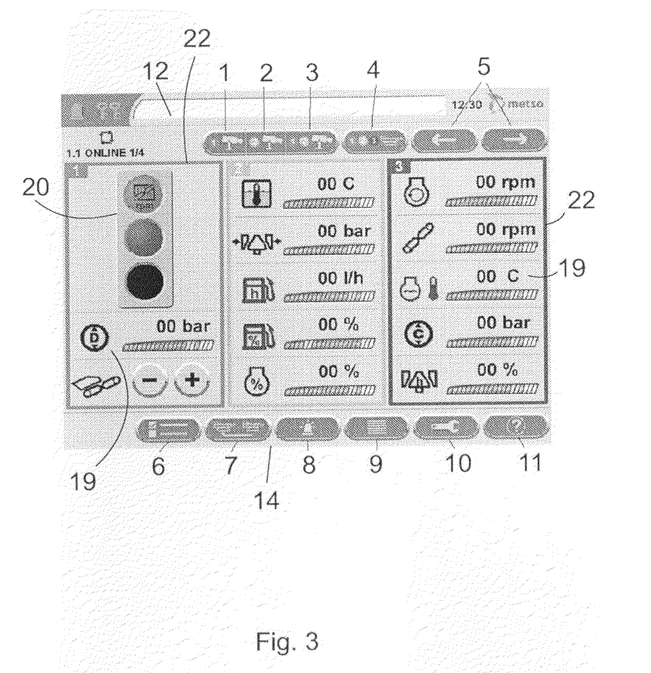

FIG. 3 shows a typical online view or “online page”, which the operator can access by selecting it among several available pages in the interface. In this example, the page shows simultaneously the status of three distinct sections or units of the mineral processing line, the sections being in this case the different machines connected in series in the equipment. On the screen the different sections are represented by rectangular fields placed next to each other, that is, the data of different sections is placed within “boxes” 22. The boxes are numbered and colour-coded. In FIG. 3, unit no. 1 corresponds to the unit B, unit no. 2 to unit C, and unit no. 3 to unit D of FIG. 1. The screen itself contains the buttons and keys that can be activated by touching them, in other words, the screen of the user interface is a so-called touch screen. The parts of the screen shown in FIG. 3 are the following:
1. Camera 1 activation (disabled if camera 1 is not in use)
2. Camera 2 activation (disabled if camera 2 is not in use)
3. Camera automatic mode on/off (disabled if camera 2 is not in use)
4. Access to view mode selection (disabled if only one unit is in use)
5. Page change inside selected view mode
6. Online page configuration (disabled if user level is 0)
7. Access to unit to unit delay times pages (disabled if only one unit is in use)
8. Access to alarm log page
9. Access to general log pages
10. Access to configuration page
11. Help page for online pages

Further, the online page of FIG. 3 also has a dynamic information field 12 in the upper part. It is intended for showing only those messages (events and warnings) that are actual. The messages disappear when they are no more relevant.

The different views can be accessed by activating the view mode selection 4.

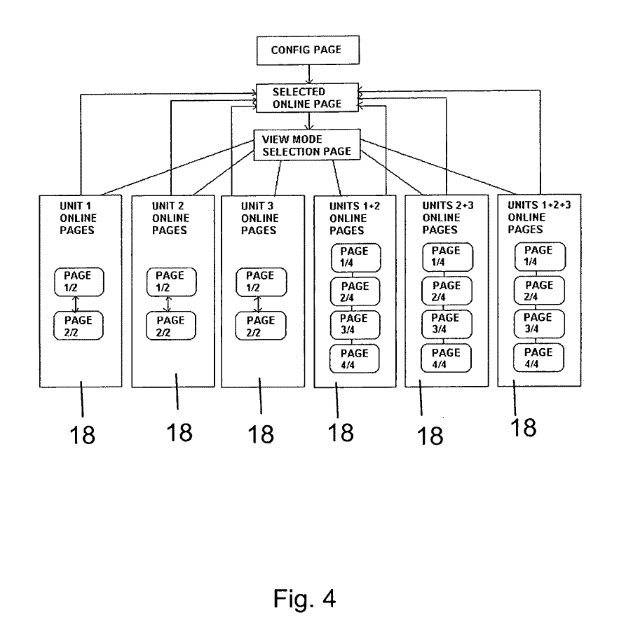

FIG. 4 shows the general navigation model of the user interface that contains different selectable pages. The operator can select online pages showing the data of one section or unit only (unit no. 1 online pages, unit no. 2 online pages and unit no. 3 online pages), or online pages that show simultaneously the data of two or several sections or units. The maximum number of sections or units is three in this example. The multi-unit pages are on the right hand side of the model. The choices containing different units or different combinations of units are called view modes 18. Inside the view mode 18 once selected, it is possible to jump between different pages (for example page 1/2 and page 2/2 of unit no. 1) by using “next” buttons 5 of FIG. 3.

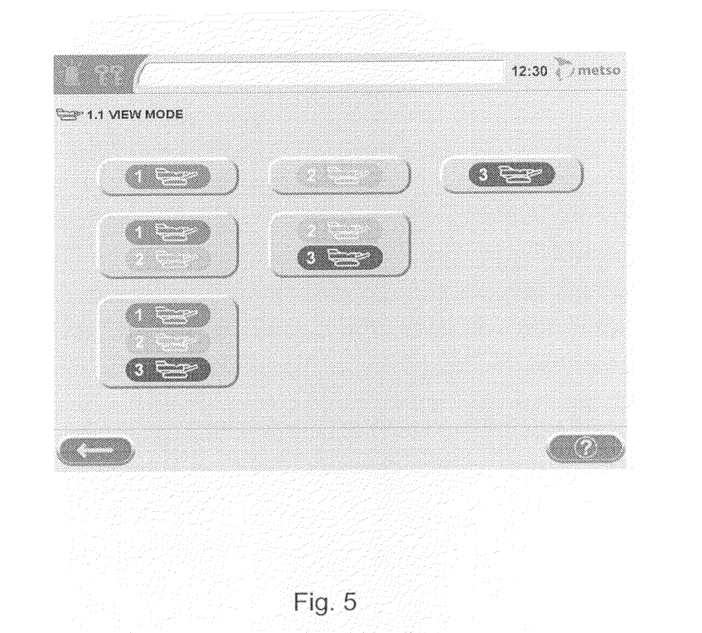

By activating the view mode selection button 4 of FIG. 3, the page shown in FIG. 5, “view mode selection page”, can be accessed. In this page, all combinations of successive units that are actually connected to the mineral processing line are shown and represented by individual buttons, which can be used to select the corresponding view mode 18.

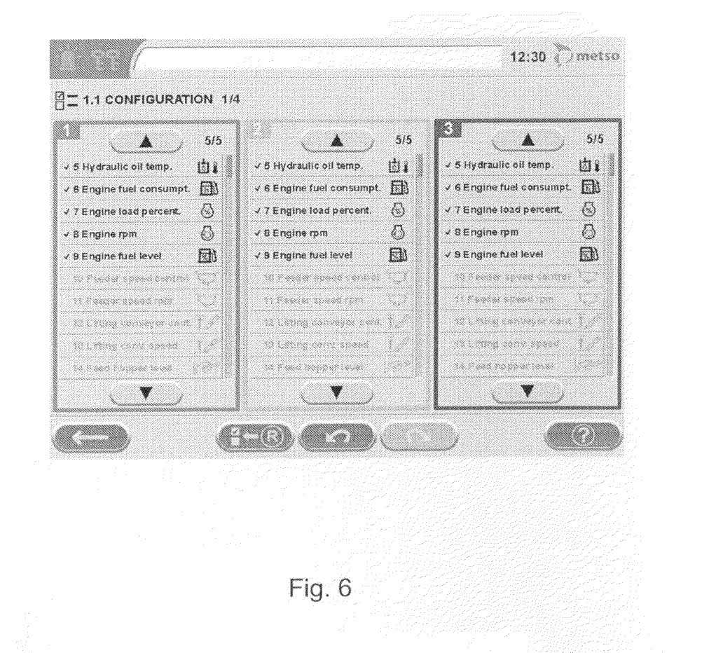

FIG. 6 shows a page which can be accessed by choosing the online page configuration button 6 of FIG. 3. With the help of this page, the operator can select the items (parameters) that he wants to monitor for each individual section or unit (machine) of the mineral processing line, “monitoring items”. In each box 22 representing a particular section or unit (machine), the monitoring items are placed one below the other. Each item is in the form of a smaller box 19 inside the box 22 of the unit, and it shows the status the equipment as a variable which is shown diagrammatically in the box 19. In addition to the diagrammatic representation, the box 19 contains also a numerical value of the variable and the symbol of the variable. The available items for each section or unit (machine) can be selected simply by activating the item on the screen (touching or “clicking”). The list of items can be scrolled up and down by using the up and down buttons. Some items may contain only numerical data.

In addition to monitoring items, the user can select so-called control items to the field or box 22 of the unit. These items can contain the symbol for the variable to be controlled and control buttons which the user can activate for giving control commands to the unit.

The user can arrange the monitoring items and the control items in a desired order in the field or box 22 on the online page, and this can be done for each online page in the view mode 18. An example of this is shown in FIG. 3, where a control item is in the lowest position inside the field or box of unit no. 1.

The exemplary view of FIG. 3 contains two camera activation buttons 1 and 2, by which a camera 16 monitoring a certain point can be activated so that a live camera view showing the online situation of the point will appear on the screen. By using the camera activation buttons, the live camera image can be accessed whenever desired. Further, the camera view can be made appear automatically when some critical state requiring attention, “attention state”, is reached in the point that the camera is monitoring. This function can be chosen by the button 3 “camera automatic mode on/off”. The camera view may appear as a “pop-up” window at a suitable area within the online page. The “attention state” may be related to a parameter that is monitored and shown on the online page in diagrammatic representation, for example level of material in the machine. It may also be triggered by an alarm function or stop function, if the function is somehow connected to the spot covered by the camera. It may also be made appear automatically when a certain measure is taken, for example a hydraulic hammer is started to clear a feeding point (large rock blocking the entry of material). Still one possibility is to activate the camera if sensors detect that a human is approaching a danger area around the machine. Of course the cameras are installed so that their fields of view cover all necessary physical spots in this respect.

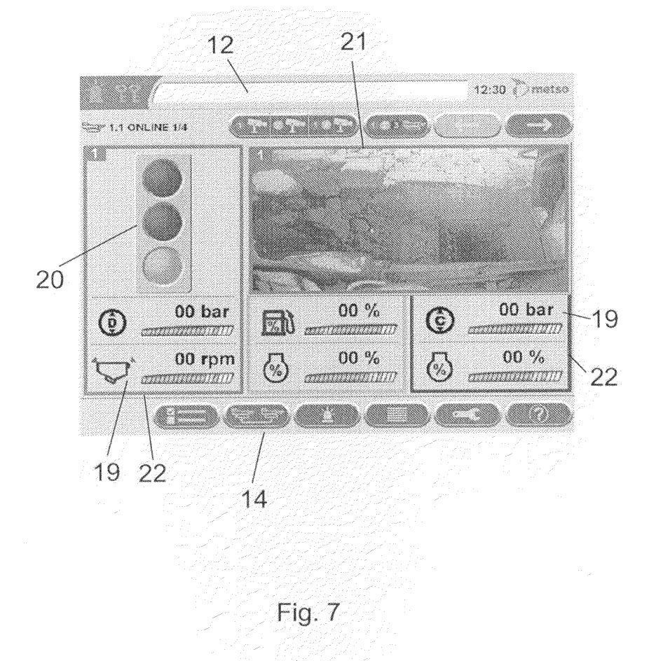

FIG. 7 shows an example of the live camera view that is visible on the screen inside a window 21 covering part of the screen. The “box” of the camera window 21 can be numbered and colour-coded so that it corresponds to the section or unit (machine) where the camera is placed. For supplementary information, the user interface shows the reason for the camera view in the dynamic information field 12 simultaneously with the camera view (the text is not shown in the field 12 in FIG. 7). The camera window 21 can contain control buttons for controlling the camera, for example position control and/or zoom (not shown in the figure). Alternatively, these camera control buttons can be available already on the online page next to the camera activation buttons 1 and 2.

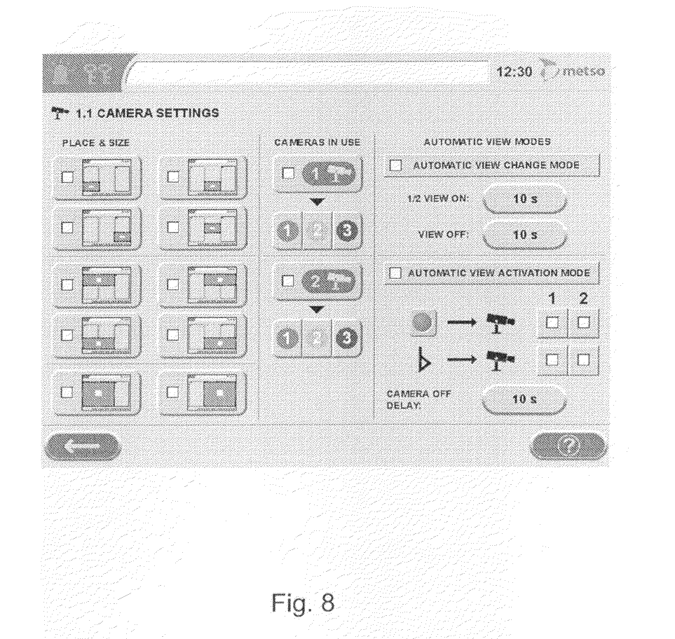

FIG. 8 shows a page which is opened by activating the camera settings button on the settings page. Place and size buttons on the left hand side can be used to define in which location the camera view (the window) will appear on the screen when it is selected manually or appearing automatically. The middle part of the page contains the “cameras in use” buttons by which cameras can be assigned to the right section so that the colour-coding and numbering of the live camera view will be correct. On the right hand side, duration of the camera view that appears on the online page can be selected, among other things. The settings place can contain also an option for multiple camera views, that is, two or more live camera images simultaneously in an online page.

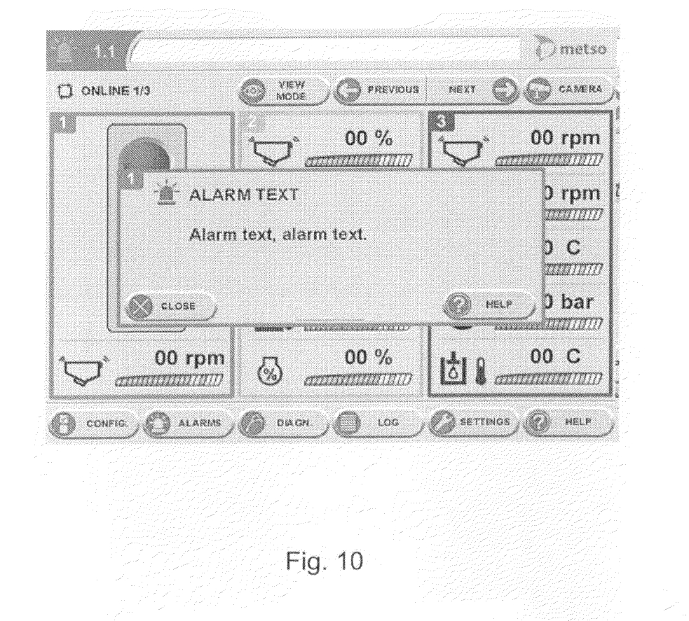

FIG. 10 is an example of an online page where alarm function has been activated. The alarm function will be triggered by faults or malfunctions in the process, and the alarm text will appear inside a pop-up window. The alarm window can have the same code (number and colour) as the unit that causes the alarm. The video image in the form of an automatic “pop-up” window may represent a lower alert level, whereas an alarm represents a higher level. However, it is possible that the camera view is triggered simultaneously with the alarm, if the camera covers the spot or area in which the alarm originates. Every time an alarm function is activated, the data is stored in a special alarm log. The alarm log page can be accessed by activating the button 8 of FIG. 3.

An advantageous function of the user interface is the diagrammatic representation of the status of individual parts of the mineral processing line that can be seen in FIG. 3 for example. The user interface is arranged to show the status, in diagrammatic representation, in various parts of two or more processing units (machines), which are located along the same processing line, but a single-unit view is also possible, as was explained above. For every unit (machine) shown in the online page, a status is shown diagrammatically for two or more parameters that describe the load or condition of a particular part, and the parameters can be selected, as presented above (FIG. 6), for each unit (machine). For illustrating which kinds of parameters can be chosen for the online page, an exemplary listing based on FIG. 3 is given below:

Field or box 22 for unit no. 1, from top to bottom:
“traffic light” related to speed (to be described later)
hydraulic device pump pressure
feed conveyor speed control

Box 22 for unit no. 2:
lubrication tank oil temperature
cone crusher pressure
engine fuel consumption
engine fuel level
engine load percentage

Box 22 for unit no. 3
engine r.p.m.
lifting conveyor speed
engine oil temperature
crusher hydraulic pump pressure
HP crusher material level % value

Each diagrammatic representation of the status of a particular part is a stepwise representation, and it is colour-coded so that different states are shown by different colours, preferably green, yellow and red, which is increasing order of attention (critical condition). The representations are preferably columns (vertical or horizontal) or a so-called “traffic-light” 20, where green-yellow-red symbolism can be used. In case of the traffic light, a particularly advantageous feature is to show the symbol of the parameter requiring attention inside the red light, such as the parameter r.p.m. in FIG. 3, which in that particular case means “screen discharge conveyor speed slow”.

In the examples shown by the figures, the diagrammatic representation of the parameter is a so-called value bar, which is stepwise so that when the bar fills from one end to the other, the parameter changes gradually from normal to critical. Colours green, yellow and red can be used in subsequent sections of this bar to illustrate the change. A numerical value of the parameter is shown in the same small box 19 where the value bar is shown.

The field or box for unit no. 1 in FIG. 3 shows a special diagrammatic representation, a so-called “traffic light” 20. The traffic light indicates always the speed of the feeding device of the unit in question. The feeding device can be a conveyor or a vibratory feeder. This speed of the feeding device is dependent on the internal automatics of the unit and reflects the efficiency of the mineral material processing. The speed means in this context every parameter that directly influences the rate with which the material is moved towards the processing step by the feeding device, that is, not only a linear speed of the conveyor but also the vibration characteristics of the vibratory feeder. Maximum speed (green light) means low load and little material going to the processing step. “Green” symbolises that the process can take more material than it is handling at the moment, that is, the capacity of the equipment is not used as it should be used. An ideal situation is when the light is yellow. The “crawling” speed of the feeding device at heavy load, the minimum speed, may be indicated by a special symbol inside the yellow light, like a turtle. Red light symbolises always a stop of the feeding device because of excess load (no actual malfunction of the equipment), for example because the minimum speed has been on for a predetermined delay time. The speed values corresponding to the “yellow” speed and the “special yellow” speed (minimum speed), in terms of percentage of maximum speed (100%, “green speed”) can be determined in advance, for example during test runs of the unit in question.

The reason for the stop may be shown as a symbol inside the red light. Some stop reasons may also activate the live camera image (if the automatic camera image activation is in use). For example high level of material that is entering a processing step in the unit may activate also the corresponding camera image in addition of stopping the feeding device. The reasons for stop function “red light” do not require special measures, because the reason for the stop is removed automatically as time passes (usually overload in some part of the machine, which is indicated by parameters such as a slow revolving speed r.p.m, high pressure, high power consumption, high temperature etc.). However, in connection of traffic lights a special “STOP” sign may be used which also indicates that the conveyor has stopped but the reason of stoppage requires special measures from the operator, and the feeding device must be restarted by a separate command.

It is also possible that every time the red light or the “STOP” sign appears in the traffic light 20, it causes the automatic activation of the camera view, provided that a camera 16 is covering the physical area in the equipment where the reason for the red light or “STOP” sign would be visible.

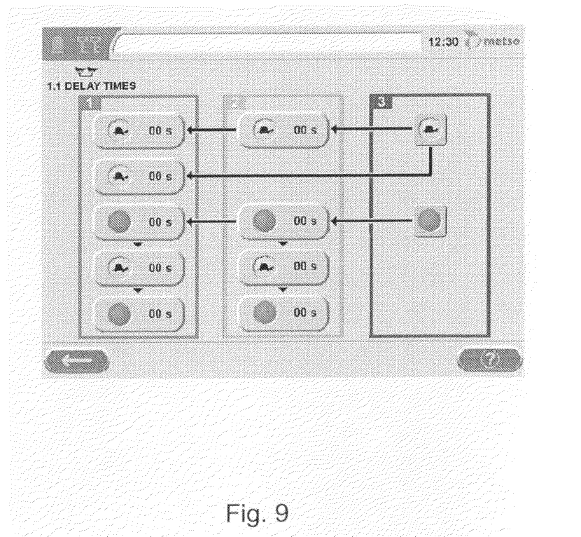

Because the units are connected in series with respect to the mineral material flow, a lowered processing rate or stop must always be taken into account in previous units. It is possible to adjust the mutual delays between the units by using the page shown in FIG. 9, the so-called unit-to-unit delay page, which can be accessed from the online page of FIG. 3 by activating the button 7. With the help of this page, the delay times of stop functions or crawling speed functions of the previous unit can be set. The delay time means in this context the time the stop function or minimum speed function starts in a unit after the corresponding function has started in the next unit (unit downstream of the material flow). Default settings are 0 sec, which means that the stop/slowing down of a unit downstream would immediately cause the stoppage/slowing down upstream. Each unit is represented by a numbered field or box as in other views. The delay times can be set by using the corresponding buttons. The delay times between units is symbolized by the arrows between the fields or boxes. The arrows lead to corresponding buttons. In all units except the last unit, the internal delay times can also be set. The internal delay times are symbolized by arrows inside the fields or boxes. The corresponding buttons for setting the internal delay times are in the lower parts of the boxes. The first button below the stop function delay time button (for setting the delay time between the units) sets the internal delay time to the start of the crawling speed again after the stop function in the same unit, and the second button sets the delay time to the restart of the stop function, that is, the running time at crawling speed till the stop again if the next unit is still under stop function.

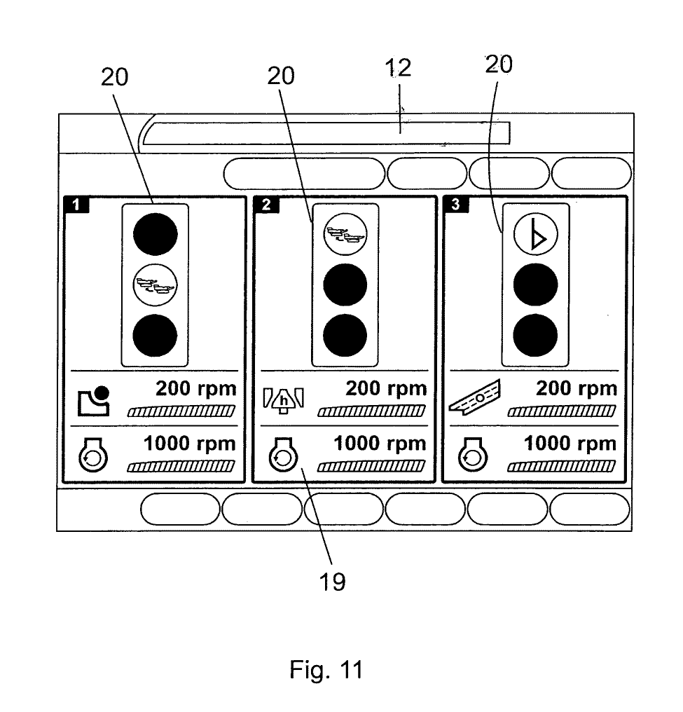

The series of traffic lights 20 helps the operator to evaluate at one glance whether the processing line is working at optimum efficiency. Green lights usually mean that the processing capacity is used only partly. When the lights are yellow, it is a sign of optimum use of the capacity. Minimum speed (symbol inside the yellow light, such as turtle) indicates that capacity is about to be exceeded. Red light in any of the units means a jam of the processing line at the corresponding unit. FIG. 11 shows a typical situation where the user has configured the online page so that it shows the “traffic light” 20 in all fields 22. The traffic lights take the place of three parameter boxes 19, and consequently, two parameter boxes 19 are left for each unit. It shows a situation where the feeding device of the tertiary unit has stopped (red light) because of high material level in the crusher (symbol inside the red light), the feeding device of the secondary unit has also stopped (red light) because of the stoppage in the tertiary unit (symbol showing this reason inside the red light) and the delay time has passed, and the primary unit has slowed down the feeding speed (yellow light) because of the stoppage in the secondary unit and/or tertiary unit (symbol inside the yellow light) and the delay time has not yet passed. This yellow light will next turn to “red” depending on the delay time chosen, and the same symbol will then appear inside the red light. By following this series of traffic lights, the operator can learn and internalize the process, and on the basis of this, adjust the delay times using the page of FIG. 9. This helps to optimize the process as a whole.

The traffic lights 20 help the operator to feed the mineral processing line in optimal way, and the operator can also gain experience about the response of the system to the feeding rate which he is using when loading the material to the mineral processing line. A special traffic light log space can keep statistics about the duration of each light for every unit B, C or D and record the reasons of stops (red lights) and their frequency. By studying the log page afterwards, it is possible to see what has been the efficiency of the process and which are the most common reasons for stop so that the operator can learn and adjust his way of working better to the process. The log page is also suitable for training. The log page can be accessed from a log navigation page, in turn accessible from the online page through button 9 (FIG. 3). The log navigation page can contain buttons for access to other log pages as well, such as alarm log and crushing log, which can show in a calendar-type manner the amount processed, processing time, energy consumption and fuel consumption.

It is preferable to place that cameras 16 so that they give live video image of the mineral material M that is being processed or transported in various parts of the equipment, so that the operator can monitor the behaviour of the material and see the abnormal situations detected by the control automatics with own eyes. However, it is also possible to place some cameras in other parts of the equipment where they do not image the material but some interior parts that are subject to disturbances.

The user interface may also have an audio function, and contain a speaker in addition to the display screen. The audio function can be activated or inactivated by choice of the operator by using a corresponding button. The button may be similar in function to other control buttons or keys of the user interface. It can be similar to buttons 1 to 11 and placed in the same area with them on online pages, like the online page shown in FIG. 3. The audio messages (spoken messages) correspond to details of visual information shown on the display screen. They can tell the status of various units of the mineral processing equipment. In case of the traffic lights, the spoken messages can tell the status of each light (colour and/or reason for the colour). If the alarm (FIG. 10) or live video image (FIG. 7) is activated, the spoken message audible at the same time can contain information related to the alarm or live video image. If the audio function is on, the operator will know instantaneously if something which deserves attention is occurring in the mineral processing equipment even if the attention of the operator is elsewhere than on the display screen.

The user interface is preferably placed in the drivers cabin of the mobile feeding or loading machine which feeds the material to the processing line that is monitored and controlled through the user interface. The operator of the user interface and the driver and operator of the feeding or loading machine is thus the same person in this case. However, it is possible that the user interface is located in a stationary control point and the mobile machine is occupied by a driver. In this case the operator of the user interface and the operator of the loading machine are different persons, which can change information by telecommunication devices. It is also possible that the feeding or loading machine is unmanned and controlled by remote control at the same control point where the user interface is located. In this case the operator of the user interface and the operator of the feeding or loading machine can be the same person.

In the foregoing detailed description, a mineral material processing equipment was shown as an example of the operation of the user interface. The user interface can also be applied to a waste material processing equipment, and all details and ideas of the user interface can be used in a waste material processing equipment that has functions analogical to a mineral processing equipment described above.

What is claimed:

1-29. (canceled)

30. User interface of a mineral or waste processing equipment, said user interface being adapted to govern a mineral or waste processing line and comprising a display screen and control buttons or keys and being connected through a data transmission link to sensors of the mineral processing equipment for receiving measurement data, said user interface being arranged to show simultaneously within the display screen
status of the mineral or waste processing equipment in diagrammatic representation, and
a live camera view of at least one point of the equipment,
wherein the user interface is arranged to show said live camera view of said at least one point
automatically when the status of the equipment reaches a predetermined attention state;
automatically when a special measure is taken in the said at least one point or when a human is approaching said at least one point, which is inside a predefined danger zone; or
when a control button, “camera button”, is used for activating a live camera view of said at least one point of the equipment.

31. The user interface according to claim 30, wherein the status of the equipment is the feeding or transporting status of the mineral or waste material at a point of the mineral or waste processing line of the equipment and the user interface is arranged to show the live camera view of the said point when the feeding or transporting status of mineral or waste material reaches a predetermined attention state.

32. The user interface according to claim 30, wherein the user interface is connected through a data transmission link to actuators of the mineral or waste processing equipment for sending control commands.

33. The user interface according to claim 30, wherein the user interface is arranged to show the live camera view at two or more points along the mineral or waste processing line.

34. The user interface according to claim 33, wherein the user interface is arranged to show the live camera view at two or more points by one camera that is movable by a remote control from the user interface.

35. The user interface according to claim 33, wherein the user interface is arranged to show the live camera view at two or more points by two or more separate cameras.

36. The user interface according to claim 30, wherein the user interface is arranged
to show the live camera view at least at the feeding point of mineral or waste raw material into a crusher of the equipment.

37. The user interface according to claim 33, wherein the user interface is arranged to show two or more live camera views simultaneously.

38. The user interface according to claim 30, wherein control buttons of the user interface are integrated in the display screen.

39. The user interface according to claim 38, wherein the display screen is a touch screen.

40. The user interface according to claim 38, wherein the buttons in the display screen are activatable by an external control device.

41. The user interface according to claim 30, wherein the user interface is arranged to show the status in diagrammatic representation of two or more processing units.

42. The user interface according to claim 41, wherein the user interface is arranged to show the status in diagrammatic representation of two or more processing units simultaneously on the same display screen in distinct areas.

43. The user interface according to claim 41, wherein the user interface is arranged to show the status in diagrammatic representation of two or more processing units which are located along the same processing line.

44. The user interface according to claim 41, wherein the user interface contains a view mode selection page showing the symbols of two or more processing units for selecting the views related to the processing units.

45. The user interface according to claim 44, wherein the view mode selection page contains two or more selectable processing unit combinations shown simultaneously on the selection page, for selecting the processing units whose status is shown simultaneously in one view.

46. The user interface according to claim 30, wherein the user interface contains a delay time page for setting functional delay times between two or more processing units located along the same mineral processing line.

47. The user interface according to claim 30, wherein the user interface is arranged to show the status in diagrammatic representations of two or more variables which indicate the loading status of the equipment.

48. The user interface according to claim 30, wherein the diagrammatic representation of the status is a stepwise representation.

49. The user interface according to claim 48, wherein the representation is a multi-level representation of the transporting speed of material in the equipment, each level being allocated a discrete area in the representation and corresponding to a predefined speed or speed range.

50. The user interface according to claim 49, wherein the user interface is arranged to show the multi-level representation concerning two or more processing units of the same mineral or waste processing line simultaneously on the same display screen.

51. The user interface according to claim 49, wherein the discrete areas of the multi-level representation are arranged to show a symbol inside the area, which symbol indicates the reason of the area that is showing the current speed or speed range.

52. The user interface according to claim 49, wherein the speed or speed range is automatically controlled by and dependent on the load of the equipment.

53. The user interface according to claim 48, wherein the diagrammatic representation of the status is color-coded.

54. The user interface according to claim 49, wherein the diagrammatic representation of the status is color-coded.

55. The user interface according to claim 53, wherein the diagrammatic representation is in the form of a column and/or traffic light.

56. The user interface according to claim 54, wherein the diagrammatic representation is in the form of a column and/or traffic light.

57. The user interface according to claim 55, wherein the colors used are red, yellow and green.

58. The user interface according to claim 56, wherein the colors used are red, yellow and green.

59. The user interface according to claim 30, wherein the user interface comprises an audio function which is arranged to emit spoken messages.

60. The user interface according to claim 30, wherein the user interface is placed in a remote control point and connected to the equipment through a wireless link.

61. The user interface according to claim 60, wherein the user interface is placed in a driver's cabin of a mobile loading machine.

62. The user interface according to claim 40, wherein the buttons in the display screen are activatable by a mouse or a joystick.
